(19) United States
(12) Patent Application Publication
(10) Pub. No.: US 2026/0106090 A1
(43) Pub. Date: Apr. 16, 2026

(54) METHOD OF CELL CONSTRUCTION

(71) Applicant: SUPERDIELECTRICS SUPERCAP LTD, Cambridge (GB)

(72) Inventor: Donald James Highgate, Cambridge (GB)

(21) Appl. No.: 19/111,663

(22) PCT Filed: Sep. 14, 2023
(86) PCT No.: PCT/GB2023/052375

§ 371 Date: Mar. 13, 2025

(30) Foreign Application Priority Data
Sep. 16, 2022 (GB) 2213660.0

(51) Int. Cl. H01G 11/52; H01G 11/32; H01G 11/58; H01G 11/84

(52) U.S. Cl. CPC H01G 11/52; H01G 11/32; H01G 11/58; H01G 11/84

(57) ABSTRACT

There is provided herein electrochemical cell comprising an electrode, an activated carbon layer, a liquid electrolyte, and a separator swellable in the liquid electrolyte. Also provided herein is a method for making an electrochemical cell, an electrochemical energy storage device comprising one or more of the electrochemical cells and a method for making the electrochemical energy storage device.

### FIELD OF THE INVENTION

The present invention relates to electrochemical cells and their construction.

### BACKGROUND OF THE INVENTION

Electrochemical cells, such as those designed to operate as supercapacitors, are conventionally constructed from two solid current carrying electrodes kept apart electrically by a membrane or separator containing an electrolyte able to mediate the passage of charge carriers (ions or electrons) between the electrodes.

Such electrochemical cells are fabricated in a number of ways, but all require the electrodes and the separators to be continuous structures able to be:
(i) made up as successive layers in a ‘flat’ geometry when the structure forms a pouch cell,
(ii) co-laminated together and then wound to form a cylindrical cell.

In either case it is normal to add the electrolyte after the electrode and separators have been laid-up.

There are numerous other variations in form and detail, but the pouch and cylindrical cell methods encompass the large majority of the manufacture processes currently used in the production of capacitors, supercapacitors and batteries.

Separators are conventionally formed into mechanically continuous sheets from woven or felted fibres or porous foams into which the chosen electrolyte can penetrate to affect the transmission of the charge carriers through the cell from electrode to electrode.

A further component of a conventional supercapacitor is activated carbon in the form of powder, or woven fabric. The function of this material is to enhance the effective surface area of the electrodes so that the effective (electrochemically active) area of the electrodes is greater than the apparent geometric area.

A common electrode structure employs an aluminium foil as the current carrying element which is coated with activated carbon powder to enhance the active area; this then forms an important part of the mechanical structure of the resulting cell whether this is manufactured in a continuous ‘roll’ type process or as discrete sections to form pouch cells.

Conventional supercapacitors most commonly employ organic electrolytes rather than aqueous systems for two principal reasons:
(i) the breakdown potential of organic electrolytes can be significantly greater than for aqueous systems (greater than 3 volts for organic electrolytes compared with less than 2 volts for aqueous electrolytes) so allowing the resulting energy storage device to store more energy,
(ii) organic electrolytes exhibit little or no corrosion when used in contact with metal components in the cell. For this reason, metallic electrodes (e.g., aluminium) of good electrical conductivity can be used, thus resulting in cells of lightweight, good manufacturability and low internal resistance.

Aqueous electrolytes have a number of advantages as compared with organic electrolytes being of low cost, and potentially of minimal environmental impact both in manufacture and at end-of-life; they are also fire resistant and provide energy storage cells of advanced energy storage when used in conjunction with hydrophilic polymer membrane separators (as taught in patent applications WO 2017/153706, WO 2017/115064 and WO 2017/115064, all of which are hereby incorporated by reference in their entirety).

However, the electrochemical processes that occur in cells operating with aqueous electrolytes are exceptionally aggressive and cause rapid corrosion of most metallic components, thus effectively preventing the use of lightweight, high electrical conductivity, metallic electrodes such as are the standard in conventional cells utilising organic electrolytes.

Effective electrochemical energy storage cells can be fabricated using aqueous electrolytes if the electrode structure is entirely non-metallic and a particularly effective combination is the use of carbon foil electrodes coated with activated carbon to provide an extended surface area.

In order to maximise the amount of activated carbon per unit area of the cell and to reduce cost, it would be desirable to use carbon in a powdered form. However, when carbon is used as a powder it is difficult to provide a compacted layer of constant and controlled thickness unless the carbon is incorporated in an adhesive matrix or ‘paint’. This is known and a suitable adhesive material is PVDF, but this restricts the amount of carbon that can be employed because the thickness of the resulting layer is limited by mechanical problems of deposition and adhesion, and most importantly the PVDF matrix blocks access to many of the carbon particles by the electrolyte. For this reason, the use of ‘loose’ carbon particles as a powder is restricted to the production of relatively small area cells when using conventional production processes and this is a major problem when attempting to volume produce cells using aqueous electrolytes.

The inventors of the present invention have devised a novel manufacturing process that addresses a number of the problems experienced if conventional production processes are applied to the production of electrochemical cells using aqueous electrolytes.

### SUMMARY OF THE INVENTION

The present invention relates to an electrochemical cell comprising:
a. an electrode
b. an activated carbon layer
c. a liquid electrolyte; and
d. a separator swellable in the liquid electrolyte.

In a preferred embodiment, the invention relates to an electrochemical cell comprising:
a. a carbon electrode
b. an activated carbon layer
c. an aqueous electrolyte; and
d. a hydrophilic polymer separator.

In a preferred embodiment, the electrochemical cell comprises:
a. a carbon electrode
b. an activated carbon layer
c. an aqueous electrolyte; and
d. a hydrophilic polymer separator,
   wherein the hydrophilic polymer separator is formed by the hydration of a dry, powdered form of the polymer by the aqueous electrolyte.

Preferably, the electrochemical cell comprises two carbon electrodes and two activated carbon layers. In the electrochemical cell, the hydrophilic polymer separator is in between the two activated carbon layers, followed by the two carbon electrodes.

According to another aspect of the present invention there is a method of making a single electrochemical cell comprising the steps of:
a. adding onto a first mould face a layer of dry, powdered swellable material
b. compressing the layer of dry, powdered swellable material so as to reduce void space within the layer
c. adding a layer of activated carbon on top of the layer of compressed dry, powdered swellable material and compressing the layer of activated carbon
d. inverting the layers so that the compressed activated carbon layer is the bottom layer and the compressed, dry, powdered swellable material layer is the top layer
e. repeating step (c) to form a second activated carbon layer
f. adding an electrode to each of the outward facing activated carbon layers to form a cell structure
g. introducing an amount of liquid electrolyte into the cell structure, wherein (i) the liquid electrolyte is absorbed by the layer of dry, powdered swellable material so that the swellable material layer expands and (ii) the liquid electrolyte fills at least 5% of the void space in the compressed activated carbon layers.

In a preferred embodiment, there is a method of making a single electrochemical cell comprising the steps of:
a. adding onto a first mould face a layer of dry, powdered hydrophilic polymer
b. compressing the layer of dry, powdered hydrophilic polymer so as to reduce void space within the layer
c. adding a layer of activated carbon on top of the layer of compressed hydrophilic polymer and compressing the layer of activated carbon
d. inverting the layers so that the compressed activated carbon layer is the bottom layer and the compressed, hydrophilic polymer layer is the top layer
e. repeating step (c) to form a second activated carbon layer
f. adding a carbon electrode to each of the outward facing activated carbon layers to form a cell structure
g. introducing an amount of aqueous electrolyte into the cell structure, wherein (i) the aqueous electrolyte hydrates the hydrophilic polymer powder so that the hydrophilic polymer layer expands and (ii) the aqueous electrolyte fills at least 5% of the void space in the compressed activated carbon layers.

According to another aspect of the present invention there is a method of making an electrochemical cell comprising a multi-layered cell stack comprising the steps of:
a. adding onto a first mould face an electrode
b. adding a layer of activated carbon on top of the electrode and compressing the activated carbon layer
c. adding a layer of dry, powdered swellable material on top of the compressed activated carbon layer and compressing the dry, powdered swellable material layer so as to reduce void space within the layer
d. adding a further layer of activated carbon on top of the compressed dry, powdered swellable material layer and compressing the activated carbon layer
e. adding a second electrode on top of the further layer of compressed activated carbon to complete the first cell
f. repeating steps (b) to (e) to form a multi-layered cell structure
g. introducing an amount of liquid electrolyte into the multi-layered structure of cells, wherein (i) the liquid electrolyte is absorbed by the layer of dry, powdered swellable material so that the swellable material layers expand and (ii) the liquid electrolyte fills at least 5% of the void space in the compressed activated carbon layers.

In a preferred embodiment, there is a method of making an electrochemical cell comprising a multi-layered cell stack comprising the steps of:
a. adding onto a first mould face a carbon electrode
b. adding a layer of activated carbon on top of the carbon electrode and compressing the activated carbon layer
c. adding a layer of dry, powdered hydrophilic polymer on top of the compressed activated carbon layer and compressing the dry, powdered hydrophilic polymer layer so as to reduce void space within the layer
d. adding a further layer of activated carbon on top of the compressed hydrophilic polymer layer and compressing the activated carbon layer
e. adding a second carbon electrode on top of the further layer of compressed activated carbon to complete the first cell
f. repeating steps (b) to (e) to form a multi-layered cell structure
g. introducing an amount of aqueous electrolyte into the multi-layered structure of cells, wherein (i) the aqueous electrolyte hydrates the hydrophilic polymer layers so that the hydrophilic polymer layers expand and (ii) the aqueous electrolyte fills at least 5% of the void space in the compressed activated carbon layers.

In a preferred embodiment, the amount of electrolyte is calculated such that it fully hydrates the hydrophilic polymer.

According to a further aspect of the present invention there is an electrochemical energy storage device comprising one or more of the electrochemical cells of the present invention.

According to a further aspect of the present invention there is an electrochemical energy storage device made according to the method of the present invention.

Advantageously, the present invention provides an electrochemical cell wherein the hydrophilic polymer separator used in the electrochemical cell is initially a dry, powdered form of the hydrophilic polymer which has until now been used as a continuous membrane.

The dry, powdered form of the hydrophilic polymer is hydrated by the aqueous electrolyte employed in the cell. In this process, the initially dry hydrophilic polymer powder may be hydrated when the individual particles expand to form a continuous separator layer. As the liquid electrolyte is absorbed by the hydrophilic particles of the dry, powdered polymer, the hydrophilic particles expand thus filling and sealing any residual spaces between the particles and forming an effectively continuous hydrophilic separator that is equivalent to the continuous membrane in a conventional cell.

Advantageously, the present invention provides an electrochemical cell wherein a layer of dry, powdered form of hydrophilic polymer is in direct contact with one or more layers of activated carbon (i.e., a layer either side of hydrophilic polymer layer, so that the hydrophilic polymer is sandwiched in between two layers of activated carbon). This means that, when the particles of the dry, powdered polymer expand upon absorption of liquid electrolyte, the polymer particles are forced into intimate contact with the adjacent activated carbon particles resulting in an excellent separator/carbon contact. As a result, an irregular interface of significantly greater effective contact area is created between the polymer separator/activated carbon layer than the simple geometric area of the interface; in effect achieving an extended surface area interface.

Advantageously, the cell can be constructed with both the polymer material and the activated carbon material being a dry, powdered material. Both the polymer material and the activated carbon material can therefore be compacted in the dry form by using any force as desired to compress the material (whereas an already hydrated membrane would be destroyed by the applied pressure necessary to produce an optimally compacted carbon structure). When the dry, powdered polymer material and carbon material are packed firmly, there is improved contact between the particles of the same type (i.e., between polymer and polymer particles, or between carbon and carbon particles) and between particles of different types (i.e., between polymer and carbon particles). Improved packing of the particles of the same or different type results in improved contact between particles, increased density of the packed material, reduced void ratio of the void material and overall increase in the energy density of the resulting electrochemical cell.

Advantageously, the method of making an electrochemical cell according to the present invention allows for larger cells and multi-layered cell stacks to be made using powdered materials. Conventionally, the use of powdered materials results in an unstable powder structure, even when applied to a horizontal substrate. This unstable powder structure cannot be moved or maneuvered as any part of the subsequent production process, without disrupting or damaging the powder structure. However, in the present method, the powdered layered are contained within a chamber until the powdered layers are fully processed, i.e., compressed against the surrounding components of the cell (the electrodes and the interior of the cell casing).

By using the method of the present invention, the size of the cell is advantageously only limited by the area of the compression equipment and no additional steps in the production process need be applied in conditions that would disrupt or damage the powder layers after initial placement.

The skilled person will appreciate that a number of the advantages outlined above may also be realised when the electrochemical cell comprises other swellable separator materials (i.e., not hydrophilic polymers) when used in conjunction with a suitable liquid electrolyte.

### BRIEF DESCRIPTION OF THE DRAWINGS

Examples of the present invention will now be described in detail with reference to the accompanying drawings, in which:

FIG. 1 is a simplified diagram of the production method of a single electrochemical cell according to the present invention.

FIG. 2 is a simplified diagram of the production method of a single electrochemical cell, including an insulating cell case, according to the present invention.

FIG. 3 is a simplified diagram of a finished electrochemical cell according to the present invention with carbon foil electrodes on the upper and lower surface.

FIG. 4 is a simplified diagram of a multi-layered cell stack according to the present invention.

### DETAILED DESCRIPTION

As used herein, the term “swellable material” refers to a material which has the ability to increase in size (i.e., swell) upon contact with a suitable liquid electrolyte, by virtue of the uptake of the liquid electrolyte into the structure of the swellable material. An aqueous electrolyte is a suitable liquid electrolyte when the swellable material is a hydrophilic material. An organic electrolyte is a suitable liquid electrolyte when the swellable material is a hydrophobic material.

As used herein, the term “polymer” takes its usual definition in the art and so refers to a homopolymer or a co-polymer formed from the polymerisation of one or more monomers. As used herein, the term “homopolymer” takes its usual definition in the art and so refers to a polymer whose polymer chains comprise one type of monomer. As used herein, the term “co-polymer” takes its usual definition in the art and so refers to a polymer whose polymer chains comprise two or more different types of monomers. As used herein the term “monomer” takes its usual definition in the art, and so refers to a molecular compound that may chemically bind to another monomer to form a polymer.

As used herein, the term “hydrophilic polymer” refers to a polymer that dissolves in water and other suitable polar liquids when it is not cross-linked, but when cross-linked absorbs water and other suitable polar liquids and swells to form a stable elastic solid, Hydrophilic polymers possess certain benefits due to their water properties.

As used herein, the term “activated carbon” takes its usual definition in the art and so refers to carbon particles that have been processed to have small, low-volume pores that increase the surface area available for adsorption or chemical reactions.

As used herein, the term “hydrate the hydrophilic polymer” means that the hydrophilic polymer takes up the hydrant, for example the aqueous electrolyte, into its structure.

As used herein, the term “the liquid electrolyte is absorbed by the layer of dry, powdered swellable material” means that the swellable material incorporates the liquid electrolyte into its structure.

As used herein, the term “aqueous electrolyte” takes its usual definition in the art, and so refers to an aqueous solution containing cations (such as potassium, sodium, calcium and magnesium) and anions (such as chloride, carbonate and phosphate).

As used herein, the term “hydrophilic polymer membrane” refers to a continuous isotropic and homogenous layer of hydrophilic polymer of substantially uniform thickness.

As used herein, the term “uniform thickness” when relating to a layer, means that the layer is substantially of the same thickness (i.e., the length across the shortest edge of the layer) across its entire length.

As used herein, the term “co-monomer mixture”, takes its usual definition in the art, and so refers to a solution or dispersion of miscible monomers that, when polymerised, forms a co-polymer.

As used herein, the term “cross-linker” refers to molecular compound capable of forming chemical bonds between polymer chains, and includes compounds such as methylenebisacrylamide, N-(1-Hydroxy-2,2-dimethoxyethyl) acrylamide, allyl methacrylate and ethylene glycol dimethacrylate. Allyl methacrylate and ethylene glycol dimethacrylate are preferred. The cross-linker may be hydrophobic or hydrophilic.

As used herein, the term “intermediate mixture” refers to a solution or dispersion to which further components are added. For instance, in the context of forming the co-monomer mixture, the term “intermediate mixture” refers to a mixture including some, but not all the components of the complete co-monomer mixture.

As used herein, the term “co-polymer” takes its usual definition in the art, and so refers to a polymer whose polymer chains comprise two or more different types of monomers.

As used herein, the term “homogenous”, when used in relation to a polymer material, refers to a polymer material whose physical properties (e.g. conductive properties and water properties) are substantially uniform throughout its entire structure.

As used herein, the term “isotropic”, when used in relation to a polymer material, refers to a polymer material whose properties are the same in all orientations.

As used herein, the term “homogenous” when used in relation to a co-monomer mixture, refers to a co-monomer solution or dispersion comprising miscible monomers that are uniformly dissolved or mixed.

As used herein, the term “electronically active material” takes its usual definition in the art and refers to a material in which the conduction process is principally dependent upon electron transfer, or in which an electron is yielded as an output at an interface.

As used herein, the term “intrinsically electronically active material” refers to a material that is electronically active without requiring further modification to be rendered electronically active.

As used herein, the term “water” as a component in the intermediate or co-monomer mixture refers to added water, i.e. water added to the remaining components not including any water already associated with the raw materials of the remaining components, e.g. when such raw materials are supplied as an aqueous solution or dispersion.

As used herein, the term “amino acid” takes its usual definition in the art, and so refers to an organic compound with amino and carboxylic acid functional groups, and a side-chain that is specific to each amino acid. The term encompasses the traditional “natural” amino acids but also any compound with an amino acid backbone (i.e. with any side-chain).

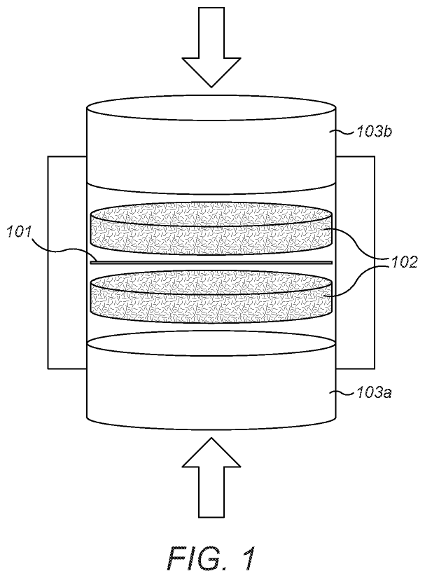

FIG. 1 is demonstrative of a cell production method using dry powdered materials, in accordance with the present invention. FIG. 1 shows a mould of suitable size and cross section for making an electrochemical cell. The mould shown in FIG. 1 has a first mould face 103a and a second mould face 103b.

As a first step, an amount of dry, powdered hydrophilic polymer is added onto the first mould face 103a. The amount of dry, powdered hydrophilic polymer added onto the first mould face 103a is calculated to provide a thickness of the resulting separator that would be comparable when hydrated to the thickness of the hydrophilic material if the separator was a conventional, continuous polymer membrane after hydration.

In a preferred embodiment, the thickness of the separator layer in the final electrochemical cell of the present invention (whether that be a single cell configuration or a multi-layered cell stack configuration) is between 25 μm to 300 μm. The preferred thickness of the separator layer is a balance between having the separator of a suitable thickness to ensure that the separator forms a continuous layer, so as to ensure that there are no short circuits in the cell, while also having the separator layer as thin as possible to maximise the energy density of the cell.

As a second step, the dry, powdered hydrophilic polymer is spread over the first mould face 103a to form a uniform layer 101 over one side of the mould face. This step may be carried out using vibration and re-spreading as necessary to achieve a layer of uniform thickness and a smooth surface.

As a third step, the second mould face 103b is brought down on top of the dry, powdered hydrophilic polymer layer and a suitable force is applied to the second mould face 103b in order to compress the polymer powder layer 101.

As a fourth step, the second mould face 103b is lifted up from the compressed polymer layer 101 to open the mould.

As a fifth step, a predetermined amount of dry activated carbon powder is added on top of the compressed polymer layer 101. As in the second step, the dry activated carbon powder may be spread over the compacted polymer layer 101 by using vibration and re-spreading as necessary to achieve a layer of uniform thickness and a smooth surface.

As a sixth step, the second mould face 103b is brought down on top of the dry activated carbon powder layer 102 and a suitable force is applied to the second mould face 103b in order to compress the carbon powder.

The same or a different force may be used to compress the carbon powder in the sixth step as compared to the force used to compact the polymer powder in the third step. Preferably, the same force is applied to the second mould face 103b in the third and sixth steps.

As a seventh step, the mould is inverted so that the polymer layer 101 is now the uppermost layer and the first mould face 103a is lifted up to open the mould.

As an eighth step, a second predetermined amount of dry activated carbon powder is added on top of the compacted polymer layer 101. This may be the same as or different from the amount used in the fifth step. As in the second step, the dry activated carbon powder may be spread over the compacted polymer layer 101 by using vibration and re-spreading as necessary to achieve a layer of uniform thickness and a smooth surface.

As a ninth step, the first mould face 103a is brought down on top of the second dry activated carbon powder layer 102 and a suitable force is applied to the first mould face 103a in order to compact the second carbon powder layer 102.

As a tenth step, the first mould face 103a is lifted up to open the mould. A carbon electrode is placed on top of the open surface (i.e., on top of the second carbon powder layer 102).

As an eleventh step, the first mould face 103a is again brought down on top of the carbon electrode so as to close the mould. The mould is then inverted, the mould opened by lifting up the second mould face 103b and a second carbon electrode is placed on top of the open surface (i.e., on top of the first carbon powder layer 102). As a result, the cell structure is now a first carbon electrode/first compressed carbon powder layer/compressed hydrophilic polymer layer/second compressed carbon powder layer/second carbon electrode, where “/” represents contact points between the layers and electrodes.

As a twelfth step, a further, optional compression step may take place using high pressure (for example, >400 kgf/cm²) to fully consolidate the layers. To carry out this step, the mould is closed and force is applied to one of the mould faces (103a or 103b).

As a thirteenth step, a calculated amount of aqueous electrolyte is added into the mould in order to (i) hydrate the hydrophilic polymer layer 101 so that the hydrophilic polymer layer expands and (ii) so that the aqueous electrolyte fills at least 5% of the void space in the compressed activated carbon layers 102.

In a preferred embodiment, the amount of aqueous electrolyte is calculated such that it fully hydrates the hydrophilic polymer.

In order to effectively wet the carbon particles with electrolyte a sufficient volume of electrolyte must be added to occupy at least 5% of the measured voidage (i.e., the volume of space between the compressed carbon particles).

This amount of liquid electrolyte can be increased but it reduces the gravimetric energy density of the resulting cell and is generally undesirable for that reason.

By the term “fully hydrates” we mean that the hydrophilic polymer is hydrated to an extent by the aqueous electrolyte such that there is no further uptake of aqueous electrolyte by the hydrophilic polymer.

As a fourteenth step, the hydrated structure is pressed through the mould and into a suitable insulated case for sealing the electrochemical cell.

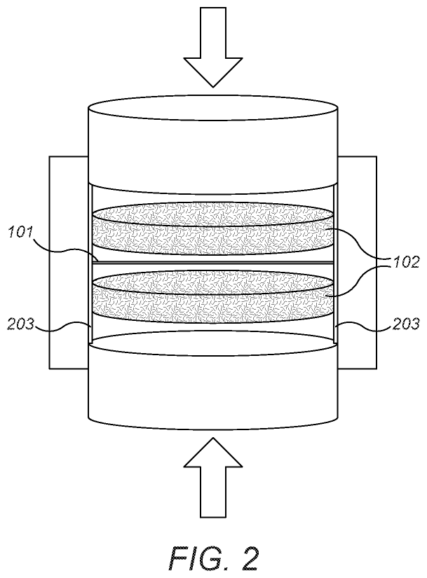

As an alternative to the fourteenth step, the cell may be made in a mould which is lined with a suitable insulating liner. A mould with an insulating liner is shown in FIG. 2.

FIG. 2 shows a mould which has an insulating liner 203 which subsequently forms the case of the resulting cell and a powdered, hydrophilic polymer layer 201 which is sandwiched in between two carbon powdered layers 202.

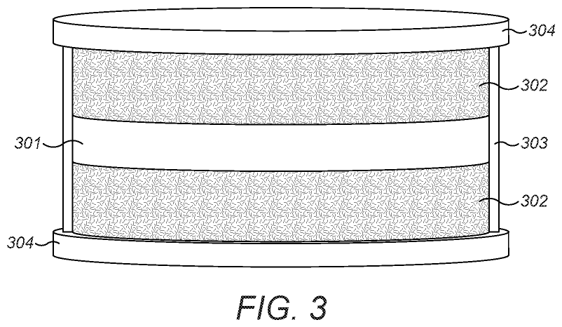

FIG. 3 shows a finished cell structure. In particular, FIG. 3 shows a hydrated hydrophilic polymer separator 301, sandwiched in between two activated carbon layers 302, with a carbon foil electrode 304 present on either end of the structure and in contact with each activated carbon layer, wherein the electrochemical cell is surrounded by an insulating case 303. At least part of each carbon foil electrode is not covered by the insulating case.

The insulating liner is made of an insulating material such as polyethylene, polypropylene, PET, polyamide or any suitable metallic tube (e.g., Al) coated internally with insulating polymer.

The insulated case and the electrodes at either end of the cell effectively seal the electrochemical cell.

The method of the present invention may also be used and adapted to create multi-layered cell stacks. The cell components described above (the carbon electrode, the hydrophilic polymer layer, the activated carbon layers) can be layered up sequentially and multiple times. This method is well suited to volume production in an automated production system.

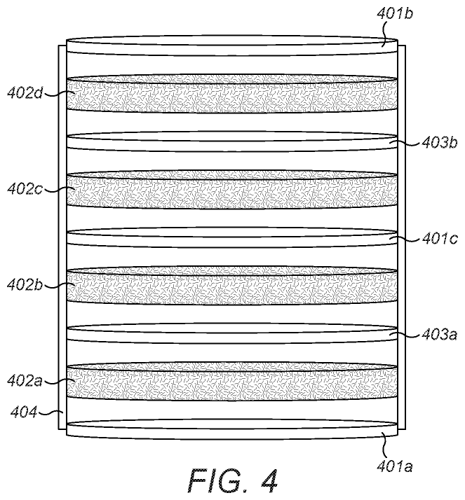

For instance, a multi-layered cell stack is shown diagrammatically in FIG. 4. FIG. 4 shows an example of a finished multi-layered cell stack shown connected for operation in a voltage series. In particular, FIG. 4 shows a multi-layered cell stack of the configuration carbon electrode 401a/activated carbon layer 402a/hydrated hydrophilic polymer separator 403a/activated carbon layer 402b/carbon electrode 401c/activated carbon layer 402c/hydrated hydrophilic polymer separator 403b/activated carbon layer 402d/carbon electrode 401b. Surrounding the multi-layered cell stack is an insulating case 404. At least part of each carbon electrode is not covered by the insulating case.

A method of making a multi-layered cell stack of electrochemical cells is outlined below.

As a first step, a first carbon electrode 401a is added onto a first mould face.

As a second step, a layer of activated carbon 402a is added on top of the carbon electrode 401a and compressed by placing a second mould face on top of the layer of activated carbon 402a and applying a force to the second mould face.

As a third step, a layer of dry, powdered hydrophilic polymer 403a is added on top of the compressed activated carbon layer 402a and the hydrophilic polymer layer 403a is compressed in the same way as outlined in the second step.

As a fourth step, a second layer of activated carbon 402b is added on top of the compressed hydrophilic polymer layer 403a and the second layer of activated carbon 402b is compressed in the same way as outlined in the second step.

As a fifth step, a second carbon electrode 401c is added on top of the compressed activated carbon layer 402b.

As a sixth step, a third layer of activated carbon 402c is added on top of the carbon electrode 401c and the third layer of activated carbon 402c is compressed in the same way as outlined in the second step.

As a seventh step, a second layer of dry, powdered hydrophilic polymer 403b is added on top of the compressed activated carbon layer 402c and the hydrophilic polymer layer 403b is compressed in the same way as outlined in the second step.

As an eighth step, a fourth layer of activated carbon 402d is added on top of the compressed hydrophilic polymer layer 403b and the fourth layer of activated carbon 402d is compressed in the same way as outlined in the second step.

As a ninth step, a third carbon electrode 401b is added on top of the compressed activated carbon layer 402d to complete the multi-layered cell structure.

As a tenth step, a calculated amount of aqueous electrolyte is added into the multi-layered structure of cells, wherein the amount of aqueous electrolyte is sufficient to (i) hydrate the hydrophilic polymer layers 403a, 403b so that the hydrophilic polymer layers expand, and (ii) so that the aqueous electrolyte fills at least 5% of the void space in the compressed activated carbon layers 402a, 402b, 402c, 402d.

In a preferred embodiment, the amount of aqueous electrolyte is calculated such that it fully hydrates the hydrophilic polymer.

The skilled person will appreciate that the sixth, seventh, eighth and ninth steps described immediately above may be repeated multiple times (e.g., 1, 2, 3, 4, 5, 6, 7, 8, 9, 10 times) to create cell stacks with an even greater number of layers. Once the cell stack has been manufactured with the desired number of layers, the tenth step (i.e., the adding of the aqueous electrolyte) is carried out as described above.

In a first alternative embodiment, multi-layered cell stack may be produced which only comprises two carbon electrodes, one at each end of the cell stack, irrespective of the number of activated carbon powder and dried, powdered hydrophilic polymer layers.

This first alternative embodiment may be demonstrated by FIG. 4, wherein layer 401c instead represents a further layer of dry, powdered hydrophilic polymer as represented by 403a and 403b. When layer 401c is a layer of dry, powdered hydrophilic polymer, this layer is added and compressed in the same way as layers 403a and 403b, as described in the third and seventh steps.

When a multi-layered cell stack comprises multiple layers stacked sequentially and on top of one another (irrespective of whether there are two or more carbon electrodes present), the multi-layered cell stack may be described as a series multi-layered cell stack.

A series multi-layered cell stack can therefore be used in a voltage series. For instance, if each cell is 2 volts and there are 3 cells, then the voltage increases in steps along the stack and a total of 6 volts will be applied to the outermost ends of the stack.

In a second alternative embodiment, several, single electrochemical cells according to the present invention may be connected in parallel.

The skilled person will appreciate that in any of the above embodiments, each layer making up the relevant cell (dry, powdered hydrophilic polymer and dry, activated carbon) may be added sequentially, with a single compression step talking place once the layers have been assembled.

Although this novel electrochemical cell and method may utilise any crosslinked polymer that will absorb and swell in the chosen electrolyte it is beneficial that it be a hydrophilic polymer material, and the resulting cells have been found to be particularly advantageous when hydrophilic polymers of the types described in WO 2017/153706, WO 2017/115064 and WO 2017/153705 and the entirety of the content of each of these applications is incorporated herein by reference.

Preferably, the hydrophilic polymer separator is a dry, powdered hydrophilic polymeric material hydrated in any suitable polar solution.

In some embodiments, the hydrophilic polymeric material may be a cross-linked hydrophilic co-polymer produced by a process comprising the steps of:
a. mixing an intrinsically electronically active material and at least one compound of formula (I) with water to form an intermediate mixture;
b. adding at least one hydrophilic monomer, at least one hydrophobic monomer, and at least one cross-linker to the intermediate mixture to form a co-monomer mixture;
c. polymerising the co-monomer mixture;
   wherein formula (I) is defined as:

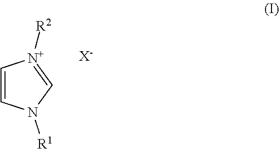

wherein:
R¹ and R² are independently optionally substituted C₁-C₆ alkyl;
X⁻ is an anion.

Preferably, X⁻ is selected from Cl⁻, C₂N₃⁻, CH₃O₃S⁻, BF₄⁻, PF₆⁻, CF₃SO₃⁻, Al₂Cl₇⁻, AlCl₄⁻NO₃⁻, OH⁻, F⁻, Br⁻, I⁻, S₂⁻, N₃⁻, O₂⁻, CO₃²⁻, ClO₃²⁻, CrO₄²⁻, CN⁻, Cr₂O₇²⁻, SCN⁻, SO₃²⁻, MnO₄⁻, CH₃COO⁻, HCO₃⁻, ClO₄⁻ and C₂O₄²⁻. Even more preferably, X⁻ is selected from Cl⁻, C₂N₃⁻; and CH₃O₃S⁻.

Preferably, the optional substituent is selected from one or more of hydroxyl, halo, NH₂, NO₂, CH₃O, CO₂H, COOOH, NR, NRR′, NHCOR and RSH, wherein R and R′ are C₁-C₆ alkyl.

Preferably, one of R¹ and R² is optionally substituted methyl, and the other is optionally substituted ethyl.

In some embodiments, the hydrophilic polymeric material may be a cross-linked hydrophilic copolymer produced by a process comprising the steps of:
(i) providing a co-monomer solution comprising at least one hydrophobic monomer, at least one hydrophilic monomer, water, at least one amino acid and at least one cross-linker; and
(ii) polymerising the co-monomer solution.

In some embodiments, the hydrophilic polymeric material may be a cross-linked hydrophilic copolymer produced by a process comprising the steps of:
(a) mixing an intrinsically electronically active material with water to form an intermediate mixture;
(b) adding at least one hydrophilic monomer, at least one hydrophobic monomer, and at least one cross-linker to the intermediate mixture to form a co-monomer mixture;
(c) polymerising the co-monomer mixture.

Preferably, the intrinsically electronically active material is selected from polyethylenedioxythiophene:polystyrene sulphonate, polypyrrole, polyaniline, polyacetylene, or a combination thereof. Even more preferably, the intrinsically electronically active material is polyethylenedioxythiophene:polystyrene sulphonate.

Preferably, the at least one hydrophilic monomer is selected from methacrylic acid, 2-hydroxyethyl methacrylate, ethyl acrylate, vinyl pyrrolidone, propenoic acid methyl ester, monomethacryloyloxyethyl phthalate, ammonium sulphatoethyl methacrylate, poly vinyl alcohol or a combination thereof. Even more preferably, the at least one hydrophilic monomer is selected from vinyl pyrrolidone and hydroxyethyl methacrylate, or a combination thereof.

Preferably, the at least one hydrophobic monomer is selected from methyl methacrylate, allyl methacrylate, acrylonitrile, methacryloxypropyltris(trimethylsiloxy) silane, 2,2,2-trifluoroethyl methacrylate, or a combination thereof. Even more preferably, the at least one hydrophobic monomer is selected from acrylonitrile and methyl methacrylate, or a combination thereof.

Preferably, the crosslinking agent is allyl methacrylate or ethylene glycol dimethacrylate.

The hydrophobic monomer and the cross-linker may be the same or different. For example, both the crosslinker and the hydrophobic monomer may be allyl methacrylate.

Preferably, the amount of water in the co-monomer mixture/intermediate mixture must be sufficient to provide a uniformly mixed homogenous solution or dispersion, and must be sufficient to uniformly disperse the intrinsically electronically active material, which is insoluble in water. The amount of water in the co-monomer mixture may be 1% to 50% by weight, preferably 5% to 50% by weight, most preferably 5% to 20% by weight based on the total weight of the co-monomer mixture.

Preferably, the at least one amino acid is selected from phenylalanine, tryptophan, histidine, ethylenediaminetetraacetic acid (EDTA) and tyrosine, or a combination thereof. Even more preferably, the at least one amino acid is selected from phenylalanine and tryptophan, or a combination thereof.

Irrespective of the polymer material used in the present invention, the polymer material must be in a dried, powdered form when it is used in the construction of an electrochemical cell according to the present invention.

This can be achieved, for example, by drying the polymer material in an oven at 110° C. for 24 to 36 hours. The skilled person will appreciate that the length of time that the polymer is in the oven for will depend on the size of the pieces of polymer. When the polymer material is dry (i.e., the polymer no longer reduces in mass due to the evaporation of water) the dried polymer material is ground in a ball mill at ambient temperature. In situations where particles of 1 to 10 μm or submicron size are desired, cryogenic grinding may be used instead of ball mill grinding.

In a preferred embodiment, the dried, powdered hydrophilic polymer material is made up of polymer particles with an average particle size when measured across the particles largest dimension of 5 μm to 500 μm. Preferably, the hydrophilic polymer particles are less than 100 μm, preferably between 5 μm and 50 μm.

When an alternative dried, powdered swellable material is used, the material is also made up of particles with an average particle size when measured across the particles largest dimension of 5 μm to 500 μm. Preferably, the swellable material particles are less than 100 μm, preferably between 5 μm and 50 μm.

The skilled person will be aware of how to measure particles of micrometre size. Nevertheless, when the polymer particles used in the present invention are required to be less than 100 μm, these particles may be selected as those which pass through a 100 μm sieve. Similarly, when the polymer particles used in the present invention are required to be less than 50 μm, these particles may be selected as those which pass through a 50 μm sieve.

In a preferred embodiment, the hydrophilic polymer layer(s) and/or one of more of the activated carbon layers are compressed using a force of at least 400 kgf/cm², preferably at least 500 kgf/cm², more preferably at least 600 kgf/cm².

In a preferred embodiment, the optional final compression step of all layers is carried out using a force of at least 400 kgf/cm², preferably at least 500 kgf/cm², more preferably at least 600 kgf/cm².

In a preferred embodiment, the activated carbon layer comprises activated carbon powder and/or activated carbon fibres. The activated carbon fibres may be provided either as a plurality of individual fibres (which can be formed by the rolling up of carbon sheets), or as a plurality of fibres woven, felted or pressed—or combinations thereof. Preferably, the activated carbon layer comprises activated carbon powder.

In a preferred embodiment, the activated carbon powder is made up of activated carbon particles with an average particle size when measured across the particles largest dimension of 10 μm to 500 μm. Preferably, the activated carbon particles are less than 200 μm, more preferably between 10 μm and 100 μm.

The skilled person will be aware of how to measure particles of micrometre size. Nevertheless, when the activated carbon particles used in the present invention are required to be less than 200 μm, these particles may be selected as those which pass through a 200 μm sieve. Similarly, when the activated carbon particles used in the present invention are required to be less than 100 μm, these particles may be selected as those which pass through a 100 μm sieve.

Although activated carbon powder is the only material referred to above it is clear that any suitable redox active species can be included in the carbon powder; either as a uniform mixture by volume, or with any desired concentration gradient through the carbon powder layer.

In a preferred embodiment, the activated carbon fibres have a length across their largest dimension of 10 μm to 1 mm. The skilled person will be aware of how to measure fibre lengths of micrometre and millimetre size using standard techniques.

In a preferred embodiment, the carbon electrodes are carbon foil electrodes.

In a preferred embodiment, the aqueous electrolyte is an aqueous solution comprising an inorganic, water soluble salt. For instance, the aqueous electrolyte may comprise a non-halide salt, such as a perchlorate. Preferably, the aqueous solution comprises one or more of NaBr, NaCl, NaI, LiCl, KBr, KCl, KOH, or H₂SO₄.

While aqueous electrolytes are the preferred electrolytes used in the present invention, the skilled person will appreciate that any suitable polar liquid or solution of polar low molecular weight solutes may be used in place of the aqueous electrolyte to form the working electrolyte.

Alternatively, in place of the aqueous electrolyte, water could be first added into the electrochemical cell structure to hydrate the dry, hydrophilic polymer layer(s) and then an additional active material could be added into the structure in order to complete the formulation of the electrolyte.

It is believed that the methods described herein can be applied to any swellable separator material when used in conjunction with a suitable liquid electrolyte; it is not limited to water or water-based electrolytes.

Without wishing to be bound by theory, when the dry, powdered hydrophilic polymer material is exposed to an aqueous electrolyte the polymer particles swell to a degree determined by the molecular structure. Typically, the expansion proceeds isotropically and the result is a hydrated material significantly larger than the original dry polymer.

This swelling is most simply described by the linear expansion ratio (x) where:

$$x = \frac{the hydrated length of the sample}{the dry length}$$

The value of x is a function both of the polymer and the particular hydrating solution and can typically range from 1.1:1 when the volume expansion will be 1.33 times, and the resulting material will be approximately 30% liquid; through to 2:1 when the volume expansion will be 8 times, and the resulting material will be approximately 85% liquid. Therefore, preferably, the expansion ratio of the hydrophilic polymer layer is greater than 1 and less than 8, more preferably between 1.2 and 2.5.

The amount of electrolyte added into the cell structure in any of the embodiments described herein must be such that the entire cell structure contains a sufficient amount of electrolyte, or is effectively wetted by a continuum of electrolyte, to facilitate passage of the charge carriers necessary for the operation of the cell.

### EXAMPLES

### Example 1

An example of a method of making a single electrochemical cell is outlined below:

A mould of suitable size and cross section is used in the production of the electrochemical cell.

˜1.5 g of dry, powdered hydrophilic polymer is introduced onto the lower mould face. The polymer is vinyl pyrrolidone, cross-linked with AMA and containing an amino acid of the type described in patent application number WO 2017/115064.

The polymer is spread over the mould face in order to form a uniform layer. This is done by using vibration and re-spreading as necessary to achieve a layer of uniform thickness and a smooth surface. The upper mould face is brought down onto the layer of hydrophilic polymer. A force of 400 kgf/cm² is used to compress the powdered, polymer layer.

The mould is then opened and ˜1.5 g of dry activated carbon powder is added on top of the compressed polymer layer. Again, the vibration and re-spreading as necessary is used to create a uniform and smooth layer of carbon powder. The upper mould face is brought down onto the layer of activated carbon powder. A force of 400 kgf/cm² is used to compress the activated carbon layer.

The mould is then inverted so that the hydrophilic polymer layer is the uppermost layer. The mould is then opened and a second amount of about ˜1.5 g of dry activated carbon powder is added on top of the compressed polymer layer. Again, the vibration and re-spreading as necessary is used to create a uniform and smooth layer of carbon powder.

The upper mould face is brought down onto the second layer of activated carbon powder. A force of 400 kgf/cm² is used to compress the activated carbon layer.

Once all three layers are assembled (two activated carbon and one hydrophilic polymer layer), a further compression stage is carried out using a force of 400 kgf/cm².

Around 6 mL of 7M NaBr solution was introduced to hydrate the hydrophilic polymer. More NaBr solution was introduced, if necessary, until at least 5% of the void space remaining in the compressed carbon powder was also filled with NaBr solution.

The hydrated structure was then pushed out of the mould and added into a suitable insulated case.

### Example 2

As outlined above, in a preferred embodiment, the amount of aqueous electrolyte is calculated such that it (i) fully hydrates the hydrophilic polymer so that the hydrophilic polymer layers expand and (ii) so that the aqueous electrolyte fills at least 5% of the void space in the activated carbon layers.

The amount of void space is measured by placing an amount of dry carbon powder on a mould and compressing the dry carbon powder with the same force that is to be used in the construction of the cell.

The mass of the dry carbon powder placed on the mould and the thickness of the dry, compressed carbon powder layer is measured in order to determine the density of the layer (kg/m³).

The density of the compressed carbon powder layer is compared with the known density of solid carbon and the difference is therefore a measure of the voidage (i.e., the volume of space between the compressed carbon particles).

1. An electrochemical cell comprising:
a. an electrode;
b. an activated carbon layer;
c. a liquid electrolyte; and
d. a separator swellable in the liquid electrolyte.

2. The electrochemical cell according to claim 1, wherein the electrode is a carbon electrode, the liquid electrolyte is an aqueous electrolyte, and/or the separator is a hydrophilic polymer separator.

3. The electrochemical cell according to claim 2, wherein the hydrophilic polymer separator is formed by the hydration of a dry, powdered form of the polymer by the aqueous electrolyte.

4. The electrochemical cell according to claim 3, wherein the dry, powdered hydrophilic polymer is formed of particles of less than 100 μm in size.

5. The electrochemical cell according to claim 1, wherein the electrochemical cell comprises two carbon electrodes and/or two activated carbon layers.

6. The electrochemical storage cell according to claim 2, wherein the aqueous electrolyte is an aqueous solution comprising one or more of NaBr, NaCl, NaI, LiCl, KBr, KCl, KOH, or H₂SO₄.

7. The electrochemical energy storage cell according to claim 2, wherein the carbon electrode is a carbon foil electrode.

8. The electrochemical cell according to claim 1, wherein the activated carbon layer comprises activated carbon powder, a plurality of individual activated carbon fibres, a plurality of activated carbon fibres woven, felted or pressed, or combinations thereof.

9. A method of making a single electrochemical cell comprising the steps of:
a. adding onto a first mould face a layer of dry, powdered swellable material;
b. compressing the layer of dry, powdered swellable material so as to reduce void space within the layer,
c. adding a layer of activated carbon on top of the layer of compressed dry, powdered swellable material and compressing the layer of activated carbon;
d. inverting the layers so that the compressed activated carbon layer is the bottom layer and the compressed, dry, powdered swellable material layer is the top layer;
e. repeating step (c) to form a second activated carbon layer;
f. adding an electrode to each of the outward facing activated carbon layers to form a cell structure; and
g. introducing an amount of liquid electrolyte into the cell structure, wherein (i) the liquid electrolyte is absorbed by the layer of dry, powdered swellable material so that the swellable material layer expands and (ii) the liquid electrolyte fills at least 5% of the void space in the compressed activated carbon layers.

10. A method of making an electrochemical cell comprising a multi-layered cell stack comprising the steps of:
a. adding onto a first mould face an electrode;
b. adding a layer of activated carbon on top of the electrode and compressing the activated carbon layer;
c. adding a layer of dry, powdered swellable material on top of the compressed activated carbon layer and compressing the dry, powdered swellable material layer so as to reduce void space within the layer;
d. adding a further layer of activated carbon on top of the compacted dry, powdered swellable material layer and compressing the activated carbon layer;
e. optionally adding a second electrode on top of the further layer of compressed activated carbon to complete the first cell;
f. repeating steps (b) to (e) to form a multi-layered cell structure; and
g. introducing an amount of liquid electrolyte into the multi-layered structure of cells, wherein (i) the liquid electrolyte is absorbed by the layer of dry, powdered swellable material so that the swellable material layers expand and (ii) the liquid electrolyte fills at least 5% of the void space in the compressed activated carbon layers.

11. The method according to claim 9, wherein the electrodes are carbon electrodes, the liquid electrolyte is an aqueous electrolyte and/or the dry, powdered swellable material is dry, powdered hydrophilic polymer.

12. The method according to claim 11, wherein the dry, powdered hydrophilic polymer is formed of hydrophilic polymer particles of less than 100 μm in size.

13. The method according to claim 9, wherein the activated carbon is formed of activated carbon particles of less than 200 μm in size.

14. The method according to claim 11, wherein the dry, powdered hydrophilic polymer layer and/or one of more of the activated carbon layers are compressed using a force of at least 400 kgf/cm², preferably at least 500 kgf/cm², more preferably at least 600 kgf/cm².

15. The method according to claim 11, wherein the amount of aqueous electrolyte added into the cell structure in step (g) is calculated such that the expansion ratio of the dry, powdered hydrophilic polymer layer is greater than 1 and less than 8, preferably between 1.2 and 2.5.

16. An electrochemical energy storage device comprising the electrochemical claim according to claim 1.

17. The electrochemical energy storage device according to claim 16 which is a supercapacitor.

18. An electrochemical energy storage device made by the method according to claim 9.

19. The method according to claim 10, wherein the electrodes are carbon electrodes, the liquid electrolyte is an aqueous electrolyte and/or the dry, powdered swellable material is dry, powdered hydrophilic polymer.

20. The method according to claim 10, wherein the activated carbon is formed of activated carbon particles of less than 200 μm in size.
